(19) United States
(12) Patent Application Publication
(10) Pub. No.: US 2025/0238677 A1
(43) Pub. Date: Jul. 24, 2025

(54) METHOD OF TRAINING GENERATIVE MODEL FOR LENGTH CONTROL AND ELECTRONIC DEVICE FOR PROCESSING DATA USING TRAINED GENERATIVE MODEL

(71) Applicant: SAMSUNG ELECTRONICS CO., LTD., Suwon-si (KR)

(72) Inventors: Seoha SONG, Suwon-si (KR); Hyeonmok KO, Suwon-si (KR); Kyenghun LEE, Suwon-si (KR)

(73) Assignee: SAMSUNG ELECTRONICS CO., LTD., Suwon-si (KR)

(21) Appl. No.: 19/013,768

(22) Filed: Jan. 8, 2025

Related U.S. Application Data
(63) Continuation of application No. PCT/KR2024/016050, filed on Oct. 22, 2024.

(30) Foreign Application Priority Data
Jan. 24, 2024 (KR) 10-2024-0010664
Jun. 27, 2024 (KR) 10-2024-0084378

(51) Int. Cl. G06N 3/09; G06N 3/0475

(52) U.S. Cl. CPC G06N 3/09; G06N 3/0475

(57) ABSTRACT

A method, performed by an electronic device, of training a generative model, the method including: obtaining a first label for an input sequence; generating a second label from the first label using a plurality of markers comprising information on a distance between a respective marker from the plurality of markers and an end point of the first label; training the generative model based on the input sequence and the second label; and modifying one or more parameters of the generative model based on the training of the generative model.

### CROSS-REFERENCE TO RELATED APPLICATIONS

This application is a continuation application of International Application No. PCT/KR2024/016050 designating the United States, filed on Oct. 22, 2024, in the Korean Intellectual Property Receiving Office and claiming the benefit under 35 USC § 119 (a) of Korean Patent Application No. 10-2024-0010664, filed on Jan. 24, 2024, and Korean Patent Application No. 10-2024-0084378, filed on Jun. 27, 2024, in the Korean Intellectual Property Office, the entire disclosures of which are incorporated herein by reference for all purposes.

### BACKGROUND

### 1. Field

The following description relates to a method of training a generative model for length control and an electronic device for processing data using a trained generative model.

### 2. Description of Related Art

A generative model may refer to a model that learns a structure and a pattern of a large volume of data and generates new data (e.g., text, audio, an image, or a video) based on input data. For example, the generative model may provide a user with an answer to a question or may provide a user with a summary of a long sequence (e.g., a text sequence). In this regard, a generative model may provide an output that is too long and difficult to comprehend. Furthermore, longer outputs are more likely to contain inaccuracies with respect to the input data.

The above information may be presented as a related art to help with the understanding of the disclosure. No arguments or decisions are made as to whether any of the above is applicable as a prior art related to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an aspect of the disclosure, a method, performed by an electronic device, of training a generative model comprises: obtaining a first label for an input sequence; generating a second label from the first label using a plurality of markers comprising information on a distance between a respective marker from the plurality of markers and an end point of the first label; training the generative model based on the input sequence and the second label; and modifying one or more parameters of the generative model based on the training of the generative model.

According to an aspect of the disclosure, the generating the second label comprises: inserting, at each of a plurality of points of the first label, a marker from the plurality of markers at a position in the first label related to the distance from each of the plurality of points to the end point of the first label.

According to an aspect of the disclosure, the obtaining the first label comprises: obtaining at least one summary of the input sequence.

According to an aspect of the disclosure, the inserting the marker comprises: inserting the marker at each of the plurality of points based on a preset rule.

According to an aspect of the disclosure, the preset rule comprises a rule with respect to at least one of a format of the marker, a first number of tokens to be positioned after a last marker, a type of a token to be positioned between two neighboring markers, and a second number of tokens to be positioned between the two neighboring markers.

According to an aspect of the disclosure, each of the plurality of markers comprises at least one token and a character that indicates the distance from the respective marker to the endpoint of the first label.

According to an aspect of the disclosure, the inserting the marker comprises: inserting a first marker before a most preceding token of the first label; and inserting one or more second markers into the first label based on the first marker.

According to an aspect of the disclosure, a character comprised in the first marker is determined based on a number of tokens positioned after a last marker among the second markers.

According to an aspect of the disclosure, the inserting of the one or more second markers includes: inserting the second markers into the first label based on the first marker at one or more periodic intervals.

According to an aspect of the disclosure, a plurality of characters comprised in the second markers are determined based on an ascending order or a descending order of the plurality of characters.

According to an aspect of the disclosure, the training of the generative model further comprises: training the generative model using the input sequence, the second label, and a rule used to generate the second label.

According to an aspect of the disclosure, the generating the second label comprises: generating a plurality of second labels from the first label.

According to an aspect of the disclosure, a first number of tokens positioned after a last marker of one of the plurality of second labels is different from a second number of tokens positioned after a last marker of another one of the plurality of second labels.

According to an aspect of the disclosure, an electronic device is configured to generate data using a generative model trained by the method comprising obtaining a first label for an input sequence; generating a second label from the first label using a plurality of markers comprising information on a distance between a respective marker from the plurality of markers and an end point of the first label; training the generative model based on the input sequence and the second label; and modifying one or more parameters of the generative model based on the training of the generative model.

According to an aspect of the disclosure, an electronic device comprises: at least one processor; and a memory configured to store one or more instructions, wherein the one or more instructions, when executed by the at least one processor, cause the electronic device to: obtain a prompt, and process the prompt, using an input sequence and a generative model trained based on a first label, to generate an output, wherein the first label is generated based on a plurality of markers comprising information on a second label for the input sequence and an end point of the second label.

According to an aspect of the disclosure, the prompt comprises information on a length of the output.

According to an aspect of the disclosure, the one or more instructions, when executed by the at least one processor, to obtain the prompt, further cause the electronic device to: generate the prompt based on user data on a playback speed of audio or a video.

According to an aspect of the disclosure, the second label comprises one or more summaries of the input sequence.

According to an aspect of the disclosure, the first label comprises a marker inserted into each of a plurality of points of the first label, and the marker is related to a distance from each of the plurality of points to an end point of the second label.

According to an aspect of the disclosure, the output comprises a summary of target information related to the prompt and a marker used to train the generative model.

Other features and aspects will be apparent from the following detailed description, the drawings, and the claims.

### BRIEF DESCRIPTION OF THE DRAWINGS

FIG. 1 is a diagram illustrating a generative system according to one or more embodiments.

FIG. 2 is a schematic block diagram of an electronic device according to one or more embodiments.

FIG. 3 is a schematic block diagram of a server according to one or more embodiments.

FIG. 4 is a diagram illustrating training process for a generative model according to one or more embodiments.

FIG. 5 is a flowchart illustrating a training process for a generative model according to one or more embodiments.

FIG. 6 is a diagram illustrating a required rule for preprocessing training data according to one or more embodiments.

FIG. 7 is a diagram illustrating an input sequence according to one or more embodiments.

FIGS. 8 to 11 are diagrams illustrating generation of a label based on accuracy according to one or more embodiments.

FIG. 12 is a diagram illustrating training data used to train a generative model according to one or more embodiments.

FIG. 13 is a diagram illustrating a label according to one or more embodiments.

FIG. 14 is a diagram illustrating a label according to one or more embodiments.

FIG. 15 is a diagram illustrating a label according to one or more embodiments.

FIG. 16 is a diagram illustrating an inference process according to one or more embodiments.

FIGS. 17 and 18 are diagrams illustrating outputs generated during an inference process according to one or more embodiments.

FIG. 19 is a flowchart illustrating operations performed by an electronic device to train a generative model according to one or more embodiments.

FIG. 20 is a flowchart illustrating operations performed by an electronic device configured to perform inference using a trained generative model according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

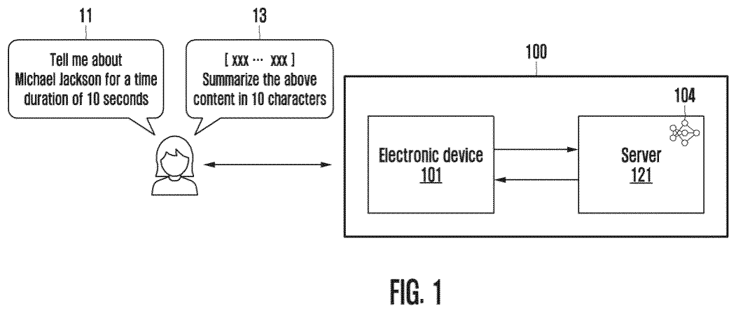

FIG. 1 is a diagram illustrating a generative system according to one or more embodiments.

Referring to FIG. 1, according to one or more embodiments, a generative system 100 may generate new data (e.g., text, audio, an image, or a video) based on input data (e.g., text, an image, audio, or a video). For example, the generative system 100 may generate an output (e.g., information about “Michael Jackson”) corresponding to a user input (e.g., a user input 11) requesting specific information. As another example, the generative system 100 may generate an output (e.g., a summary) corresponding to a user input (e.g., a user input 13) requesting to summarize information. For example, in user input 13, the user may provide a sequence of information with a request to summarize the information. The sequence of information may be a separate audio file, image data, or text file.

According to one or more embodiments, the generative system 100 may include an electronic device 101 and a server 121. The generative system 100 may generate new data using a generative model 104. The generative model 104 may be a model generated by training a pre-trained model or an untrained model using training data (e.g., a dataset). The generative model 104 may be included in the server 121 (e.g., a cloud-based generative model), but as understood by one of ordinary skill in the art, the embodiments are not limited to these configurations. For example, the generative model 104 may be included in the electronic device 101 (e.g., an on-device generative model) or may be included in both the electronic device 101 and the server 121. Depending on the implementation of the generative model 104, at least one of operations performed by the electronic device 101 described below may be performed by the server 121 or at least one of operations performed by the server 121 may be performed by the electronic device 101. In one or more examples, the electronic device 101 may be a device configured to communicate over the Internet with a remote server or one or more cloud services that include the generative model 104. For example, the user may provide input 11 or input 13 to the electronic device, where the input is transmitted over the Internet to the generative model.

According to one or more embodiments, the generative model 104 may include a pattern recognition model (e.g., LLaMa, falcon, or transformer). The pattern recognition model may learn a pattern and/or regularity of data and may predict, synthesize, and/or generate new data. For example, a language model (e.g., a large language model (LLM)) may perform various language-related tasks (e.g., test generation, translation, or summarization) by identifying a language-related pattern (e.g., a token pattern) from text data (e.g., a word, a sentence, a paragraph, or a document).

According to one or more embodiments, the electronic device 101 may obtain a user input (e.g., the user input 11 or 13). The user input may include a text input and/or a voice input. The electronic device 101 may convert the voice input into text data using automatic speech recognition (ASR).

According to one or more embodiments, the electronic device 101 may generate a prompt based on the user input. The prompt may be data to initiate interaction with the generative model 104. For example, the prompt may include natural language text. The natural language text may include information, such as context, intent, a task, and/or a constraint (e.g., the length of an output). The electronic device 101 may transmit the prompt to the server 121. Accordingly, the prompt may represent a transformation or annotation of the user input.

According to one or more embodiments, the server 121 may generate data based on the prompt using the generative model 104. For example, the generative model 104 may generate an answer or response (e.g., information having a specific token length about an object, such as “Michael Jackson”, included in the user input 11) to the user input 11. As another example, the generative model 104 may generate a summary of text or audio included in the user input 13. The generative model 104 may use a retrieving module to generate the data. The retrieving model may be implemented as a part of the generative model 104 or may be included in the server 121 (or the electronic device 101) separately from the generative model 104. The retrieving module may obtain data from an internal data source (e.g., an information storage in a memory) and/or an external data source (e.g., a data source on the Internet). For example, the generative model 104 may search the Internet for information about “Michael Jackson” using the retrieving module to provide an answer to the user input 11.

According to one or more embodiments, the server 121 may post-process data (e.g., a summary) generated by the generative model 104, as necessary. The server 121 may transmit the data generated by the generative model 104 or the post-processed data to the electronic device 101. The electronic device 101 may visually or audibly provide the data received from the server 121 to a user.

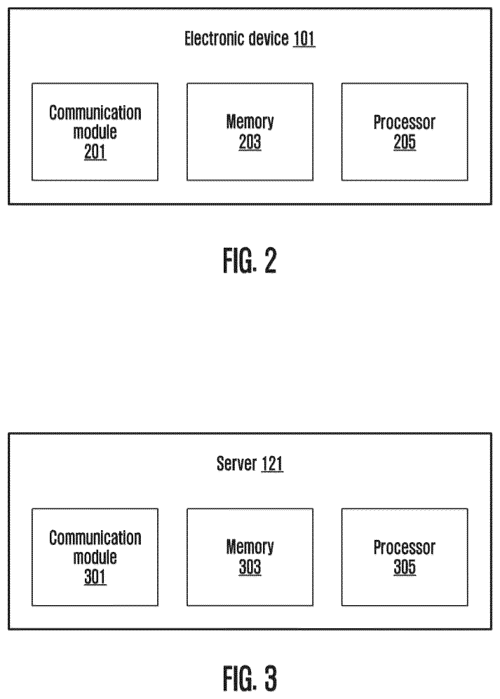

FIG. 2 is a schematic block diagram of an electronic device according to one or more embodiments.

Referring to FIG. 2, according to one or more embodiments, the electronic device 101 may include a communication module 201, a memory 203, and a processor 205.

According to one or more embodiments, the communication module 201 may establish a communication channel for communication (e.g., wired communication and/or wireless communication) between the electronic device 101 and an external electronic device (e.g., the server 121 of FIG. 1). The communication module 201 may operate independently of the processor 205 or mutually cooperatively with the processor 205.

According to one or more embodiments, the communication module 201 may include at least one communication processor that supports wired communication and/or wireless communication.

According to one or more embodiments, the communication module 201 may include a communication circuit that supports data communication between the electronic device 101 and an external electronic device (e.g., the server 121) using at least one of data communication schemes, such as a wired local area network (LAN), a wireless LAN, wireless fidelity (Wi-Fi), Bluetooth, ZigBee, Wi-Fi direct (WFD), infrared data association (IrDA), Bluetooth low energy (BLE), near field communication (NFC), wireless broadband Internet (Wibro), world interoperability for microwave access (WiMAX), shared wireless access protocol (SWAP), wireless gigabit alliances (WiGig), and/or radio frequency (RF) communication.

According to one or more embodiments, the processor 205 may control at least one component (e.g., a hardware or software component) of the electronic device 101 connected to the processor 205 by executing software (e.g., a program) and may perform various data processing or operations.

According to one or more embodiments, as at least a part of data processing or operations, the processor 205 may store instructions or data received from another component (e.g., the communication module 201) in the memory 203, may process the instructions or the data stored in the memory 203, and may store result data in the memory 203.

According to one or more embodiments, the processor 205 may include a main processor (e.g., a central processing unit (CPU) or an application processor (AP)) or an auxiliary processor (e.g., a graphics processing unit (GPU), a neural processing unit (NPU), an image signal processor (ISP), or a sensor hub processor) that is operable independently of or in conjunction with the main processor. For example, when the electronic device 101 includes the main processor and the auxiliary processor, the auxiliary processor may be adapted to consume less power than the main processor or to be specific to a specified function. The auxiliary processor may be implemented separately from the main processor or may be implemented as a part of the main processor.

According to one or more embodiments, the auxiliary processor may control at least some of functions or states related to at least one (e.g., the communication module 201) of components of the electronic device 101 instead of the main processor while the main processor is in an inactive (e.g., sleep) state or along with the main processor while the main processor is in an active (e.g., executing an application) state.

According to one or more embodiments, the auxiliary processor (e.g., the neural processing unit) may include a hardware structure specified for artificial intelligence (AI) model processing. An AI model may be generated by training (e.g., machine learning). The training may be performed by a device (e.g., the electronic device 101 or the server 121) configured to perform inference using a trained AI model or may be performed by a separate device. Learning algorithms may include supervised learning, unsupervised learning, semi-supervised learning, or reinforcement learning, but the example is not limited thereto. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure. In one or more examples, the AI model may correspond to the generative model 104.

According to one or more embodiments, the memory 203 may store a variety of data used by at least one component (e.g., the processor 205 or the communication module 201) of the electronic device 101. The data may include software (e.g., an artificial neural network, an application, or a program) and input data or output data for instructions related thereto. The memory 203 may include volatile memory or non-volatile memory.

According to one or more embodiments, when the instructions stored in the memory 203 are individually or collectively executed by at least one processor (e.g., the main processor and/or the auxiliary processor), the instructions may cause the electronic device 101 to perform one or more instructions. For example, the instructions stored in the memory 203 may be executed by one processor (e.g., the main processor or the auxiliary processor) or a plurality of processors (e.g., the main processor and the auxiliary processor) operating cooperatively.

FIG. 3 is a schematic block diagram of a server according to one or more embodiments.

Referring to FIG. 3, according to one or more embodiments, the server 121 may include a communication module 301, a memory 303, and a processor 305.

According to one or more embodiments, the communication module 301 may establish a communication channel for communication (e.g., wired communication and/or wireless communication) between the server 121 and an external electronic device (e.g., the electronic device 101 of FIG. 1). The communication module 301 may operate independently of the processor 305 or mutually cooperatively with the processor 305.

According to one or more embodiments, the communication module 301 may include at least one communication processor that supports wired communication and/or wireless communication.

According to one or more embodiments, the communication module 301 may include a communication circuit that supports data communication between the server 121 and an external electronic device (e.g., the electronic device 101) using at least one of data communication schemes, such as a wired LAN, a wireless LAN, Wi-Fi, Bluetooth, ZigBee, WFD, IrDA, BLE, NFC, Wibro, WiMAX, SWAP, WiGig, and/or RF communication.

According to one or more embodiments, the processor 305 may control at least one component (e.g., a hardware or software component) of the server 121 connected to the processor 305 by executing software (e.g., a program) and may perform various data processing or operations.

According to one or more embodiments, as at least a part of data processing or operations, the processor 305 may store instructions or data received from another component (e.g., the communication module 301) in the memory 303, may process the instructions or the data stored in the memory 303, and may store result data in the memory 303.

According to one or more embodiments, the processor 305 may include a main processor (e.g., a CPU) or an auxiliary processor (e.g., a GPU, an NPU, an ISP, or a sensor hub processor) that is operable independently of or in conjunction with the main processor. For example, when the server 121 includes the main processor and the auxiliary processor, the auxiliary processor may be adapted to consume less power than the main processor or to be specific to a specified function. The auxiliary processor may be implemented separately from the main processor or may be implemented as a part of the main processor.

According to one or more embodiments, the auxiliary processor may control at least some of functions or states related to at least one (e.g., the communication module 301) of components of the server 121, instead of the main processor while the main processor is in an inactive (e.g., sleep) state or along with the main processor while the main processor is in an active (e.g., executing an application) state.

According to one or more embodiments, the auxiliary processor (e.g., the neural processing unit) may include a hardware structure specified for artificial intelligence (AI) model processing. An AI model may be generated by training (e.g., machine learning). The training may be performed by a device (e.g., the server 121 or the electronic device 101) configured to perform inference using a trained AI model or may be performed by a separate device. Learning algorithms may include supervised learning, unsupervised learning, semi-supervised learning, or reinforcement learning, but the example is not limited thereto. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure. In one or more examples, the AI model may correspond to the generative model 104.

According to one or more embodiments, the memory 303 may store a variety of data used by at least one component (e.g., the processor 305 or the communication module 301) of the electronic device 101. The data may include software (e.g., an artificial neural network, an application, or a program) and input data or output data for instructions related thereto. The memory 303 may include volatile memory or non-volatile memory.

According to one or more embodiments, when the instructions stored in the memory 303 are individually or collectively executed by at least one processor (e.g., the main processor and/or the auxiliary processor), the instructions may cause the server 121 to perform one or more instructions. For example, the instructions stored in the memory 303 may be executed by one processor (e.g., the main processor or the auxiliary processor) or a plurality of processors (e.g., the main processor and the auxiliary processor) operating cooperatively.

FIG. 4 is a diagram illustrating a process to train a generative model according to one or more embodiments.

Referring to FIG. 4, according to one or more embodiments, a data processing module 401 and/or a generative model 403 may be a function implemented by software (e.g., an instruction and/or a program) stored in a memory (e.g., the memory 203 of FIG. 2 and/or the memory 403 of FIG. 3) of a device (e.g., the electronic device 101 of FIGS. 1 and 2 and/or the server 121 of FIGS. 1 and 3). FIG. 4 is schematically illustrated to describe a training process, and as understood by one of ordinary skill in the art, various modifications are possible. For example, the data processing module 401 may be implemented as a part of the generative model 403 or may be implemented by being divided into a plurality of modules.

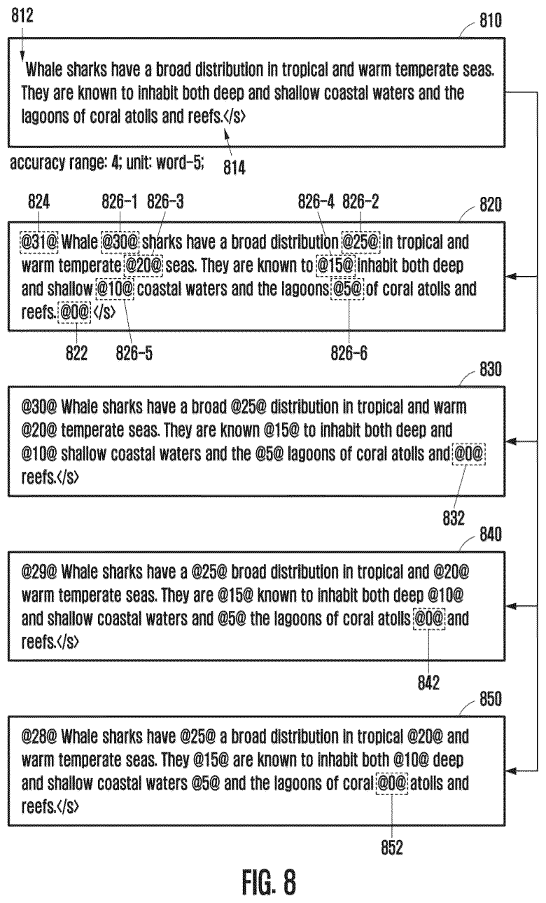

According to one or more embodiments, the data processing module 401 may obtain training data (e.g., an input sequence and a label) required to train the generative model 403. For example, the data processing module 401 may obtain a text sequence (e.g., a full-length text sequence 710 of FIG. 7) and a first label (e.g., a first label 810 of FIG. 8) with respect to the text sequence 710.

In one or more examples, the training may be based on supervised training data or unsupervised training data. According to one or more embodiments, the training data may be provided by a user, but the example is not limited thereto. For example, the training data may be obtained by data generated by a generative model (e.g., a trained language model) other than the generative model 403. In the context of AI, the label may be ground truth data (answer data) to be predicted (or generated) from the input data by an AI model (e.g., the generative model 403). Depending on a type of a neural network, various types of labels may be used to train the AI model. In one or more examples, the label may be summary data that compresses and provides information included in an input sequence (e.g., the full-length text sequence 710 of FIG. 7). In one or more examples, for ease of description, the text sequence is described as an example of the input sequence. However, as understood by one of ordinary skill in the art, the input sequence is not limited to the text sequence. For example, data (e.g., audio data or video data) in which a temporal relationship and/or a contextual relationship between data from a previous step and data from a next step may be considered may be included in the scope of the present disclosure.

According to one or more embodiments, the data processing module 401 may perform first preprocessing on the input sequence. In one or more examples, the first preprocessing may be a process of adding additional information to the first label 810 of the input sequence 710 such that the generative model 403 is able to control a length (e.g., a time length or a token length) of an output with high accuracy. For the first preprocessing, the data processing module 401 may insert one or more markers including information on an end point (e.g., an end point 814 of FIG. 8) of the first label 810 into the first label 810. For example, the data processing module 401 may generate a marker at each of a plurality of points of the first label 810, wherein the marker is related to a distance from each point to the end point 814. The first preprocessing is further described with reference to FIGS. 7 to 15. In one or more examples, the input sequence may be annotated with the additional information. For example, the additional information may be annotated to the input sequence. In one or more examples, the additional information may be a separate input into the generative model. The additional information may be provided by the user as additional text, audio, and/or video. In one or more examples, the additional information may be predetermined based on one or more user settings (e.g., user setting may specify that output responses are limited to 10 words).

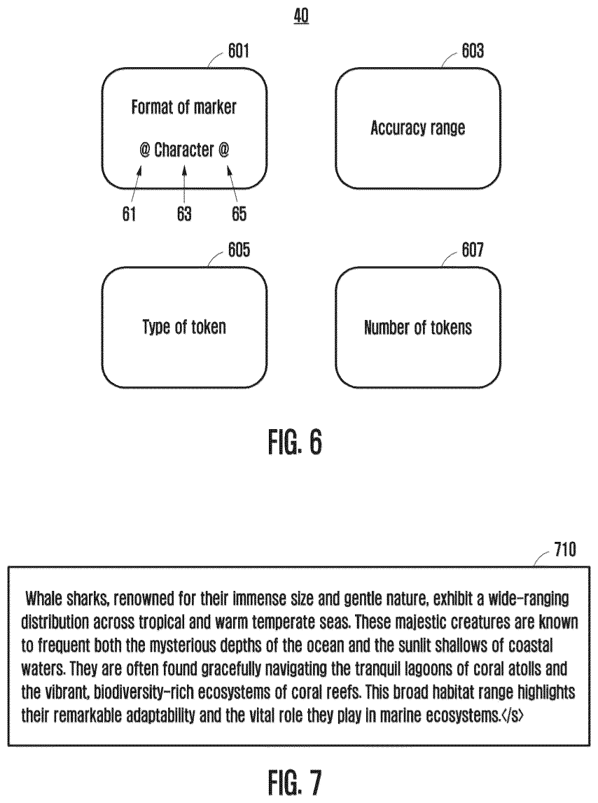

According to one or more embodiments, the data processing module 401 may perform first preprocessing based on a preset rule 40. The preset rule 40 is further described with reference to FIG. 6.

According to one or more embodiments, the data processing module 401 may perform second preprocessing on the input sequence. In one or more examples, the second preprocessing may include general preprocessing for natural language processing, such as text cleaning, tokenizing, removing a stop word, sentence segmentation, part-of-speech tagging, and/or name entity recognition. In the context of natural language processing, a token may be a fundamental unit for analysis. The token may be set to units of various sizes, such as a word, a sentence, or a paragraph. Tokenization may include a task of breaking down raw text (e.g., a full-length text sequence) into a set token (e.g., a word, a sentence, or a paragraph).

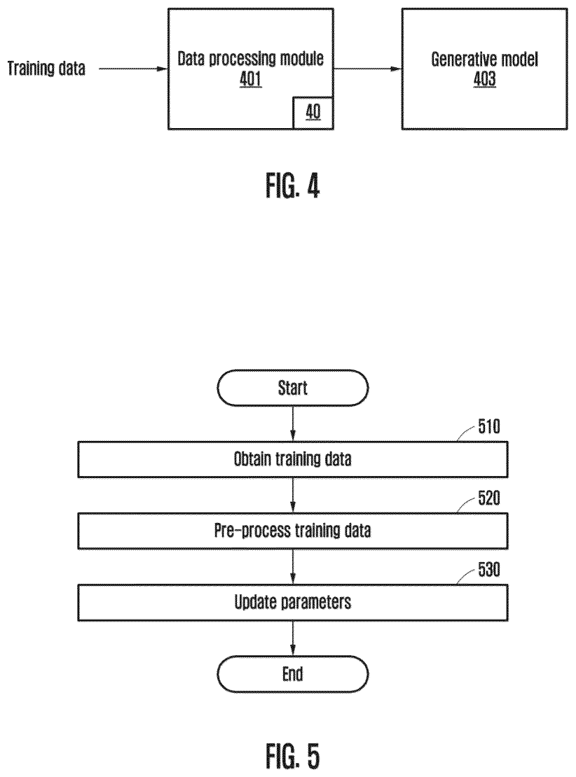

According to one or more embodiments, the generative model 403 may be trained based on an input sequence and a label (e.g., a second label) preprocessed by the data processing module 401. The generative model 403 may include a pre-trained generative model. A training process of the generative model 403 is further described with reference to FIG. 5.

FIG. 5 is a flowchart illustrating a training process for a generative model according to one or more embodiments.

Referring to FIG. 5, according to one or more embodiments, operations 510 to 530 may be sequentially performed but are not limited thereto. For example, two or more operations may be performed in parallel, one or more operations may be omitted, or a new operation may be added. As described above, a generative model (e.g., the generative model 403 of FIG. 4) may be trained by a device (e.g., the electronic device 101 of FIGS. 1 and 2 and/or the server 121 of FIGS. 1 and 3) that performs inference, but in one or more examples, may be trained by a separate device. Hereinafter, for ease of description, a training process is described based on an assumption that the generative model 403 is trained by the server 121.

In operation 510, the server 121 may obtain training data (e.g., the full-length text sequence 710 of FIG. 7) and the first label 810. In one or more examples, the training data may be supervised training data or unsupervised training data.

In operation 520, the server 121 may perform preprocessing (e.g., the first preprocessing and/or the second preprocessing of FIG. 4) on the obtained training data.

In operation 530, the server 121 may update parameters of the generative model 403 (e.g., a pre-trained model) using the preprocessed training data. For example, the server 121 may update the parameters of the generative model 403 to minimize a difference between an output of the generative model 403 and the preprocessed label through forward propagation and backpropagation. For example, the server 121 may update parameters based on the slope of a loss function (e.g., a cross-entropy loss, a mean squared error (MSE), or Kullback-Leibler divergence). In one or more examples, the parameters may be updated to minimize the loss function.

FIG. 6 is a diagram illustrating a required rule for preprocessing training data according to one or more embodiments.

Referring to FIG. 6, according to one or more embodiments, a data processing module (e.g., the data processing module 401 of FIG. 4) may perform first preprocessing on training data (e.g., the first label 810 of FIG. 8) based on the preset rule 40.

According to one or more embodiments, the preset rule 40 may be stored in a memory (e.g., the memory 303 of FIG. 3) of a device (e.g., the server 121 of FIGS. 1 and 3). In one or more examples, the preset rule 40 may be updated based on information received over the Internet. The preset rule 40 may include one or more rules required to insert a marker into a first label (e.g., the first label 810) with respect to an input sequence (e.g., the full-length text sequence 710 of FIG. 7). For example, the preset rule 40 may include rules 601 to 607.

According to one or more embodiments, the rule 601 may include information on the format of the marker. For example, the marker may include at least one special token (e.g., special tokens 61 and 65 and a character 63 that is able to express an order (e.g., ascending order or descending order)). For example, the character 63 may include a number or a letter (e.g., an alphabet). The character 63 may provide information about distance from a current marker to a last marker in a label. The special token may represent a token that performs a specific function (e.g., a separator) or expresses a particular concept other than a natural language vocabulary. The special token may provide pattern information (e.g., a pattern of a token) required for a generative model (e.g., the generative model 403 of FIG. 4) to process a natural language (e.g., text), contextual information, and/or syntactical information.

According to one or more embodiments, the rule 603 may include information on an accuracy range 603. In one or more examples, the accuracy range 603 may represent a limit on the number of tokens (e.g., words, sentences, or paragraphs) positioned after a last marker (e.g., markers 822, 832, 842, or 852 of FIG. 8) among markers inserted into the first label (e.g., the first label 810 of FIG. 8). The accuracy range 603 is further described with reference to FIGS. 7 to 11 and FIG. 14.

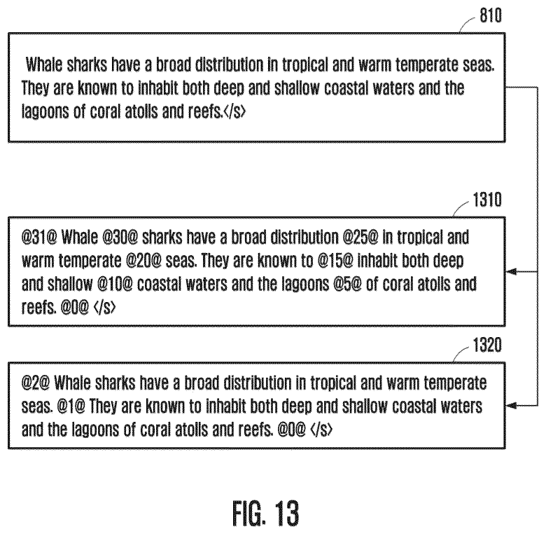

According to one or more embodiments, the rule 605 may include information on a type (e.g., a word, a sentence, or a paragraph) of a token to be positioned between two neighboring markers (e.g., markers 826-1 and 826-2 of FIG. 8). For example, the data processing module (e.g., the data processing module 401 of FIG. 4) may insert a marker between tokens (e.g., words, sentences, or paragraphs) of a specific type, based on the rule 605. The rule 605 is further described with reference to FIG. 13.

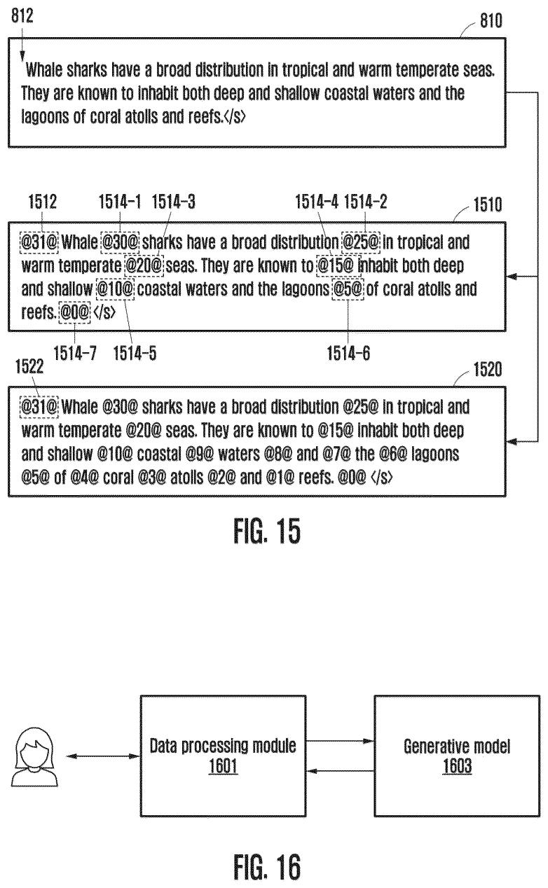

According to one or more embodiments, the rule 607 may include information on the number of tokens to be positioned between two neighboring markers (e.g., the markers 826-1 and 826-2 of FIG. 8). For example, n (e.g., “5” or “10”) tokens (e.g., words) may be included between two neighboring markers. The rule 607 is further described with reference to FIG. 15.

FIG. 7 is a diagram illustrating an input sequence according to one or more embodiments.

Referring to FIG. 7, according to one or more embodiments, the full-length text sequence 710 may be used as a part of training data to train a generative model (e.g., the generative model 403). In one or more examples, for ease of description, a text sequence expressed in English is described as an example. However, as understood by one of ordinary skill in the art, the technical idea of the present disclosure may be applied to other word languages (e.g., Korean, Japanese, or Chinese) other than English.

FIGS. 8 to 11 are diagrams illustrating generation of a label based on an accuracy range according to one or more embodiments. FIGS. 8 to 11 are illustrated based on a case in which a rule (e.g., the rule 605 of FIG. 6) related to a type of a token is set to a “word”, and a rule (e.g., the rule 607 of FIG. 6) related to the number of tokens is set to “periodically, 5 tokens”.

Referring to FIGS. 8 to 11, according to one or more embodiments, a data processing module (e.g., the data processing module 401 of FIG. 4) may generate one or more second labels (e.g., labels 820 to 850, labels 910 to 930, labels 1010 and 1020, or a label 1110) from the first label 810 for an input sequence (e.g., the full-length text sequence 710 of FIG. 7), based on a preset rule (e.g., the preset rule 40 of FIGS. 4 and 6).

For example, when a rule (e.g., the rule 603 of FIG. 6) related to an accuracy range is set to “4”, 0 to 3 tokens (e.g., words) may be positioned after the last marker (e.g., the marker 822, 832, 842, or 852). Accordingly, the data processing module 401 may generate one or more second labels (e.g., the second labels 820 to 850). The second label 820 may be a label when 0 word is positioned after the last marker 822. The second label 830 may be a label when one word (e.g., “reefs”) is positioned after the last marker 832. The second label 840 may be a label when two words (e.g., “and reefs”) are positioned after the last marker 842. The second label 850 may be a label when three words (e.g., “atolls and reefs”) are positioned after the last marker 852.

According to one or more embodiments, the data processing module 401 may insert a marker (e.g., the marker 824) into a starting point 812 of the first label 810. The data processing module 401 may periodically, semi-periodically, or non-periodically insert one or more markers (e.g., markers 822, 826-1 to 826-6) after a marker (e.g., the marker 824) that is inserted into the starting point 812. A character included in the marker (e.g., the marker 824) inserted into the starting point 812 may be determined based on the number of tokens (e.g., words) included in the first label 810 or the number of tokens (e.g., words) positioned after the last marker (e.g., the marker 822). For example, when 31 words are included in the first label 810 and 0 words are positioned after the last marker 822, the character included in the marker 824 may be 31. In another example, marker 826-1, which is placed one word after marker 824, may include the character 30 to indicate that there are 30 words between the marker 826-1 and the last marker 822. However, in one or more examples, since the marker is to provide information on an end point of a label and/or pattern information (or context information) of a token to a generative model (e.g., the generative model 403 of FIG. 4), one of ordinary skill in the art would understand that various modifications are possible other than the embodiments explicitly illustrated in the present disclosure. For example, the markers included in the second label 820 may have a format, such as ‘@62@’, ‘@60@’, ‘@50@’, ‘@40@’, ‘@30@’, ‘@20@’, ‘@10@’, and ‘@0@’.

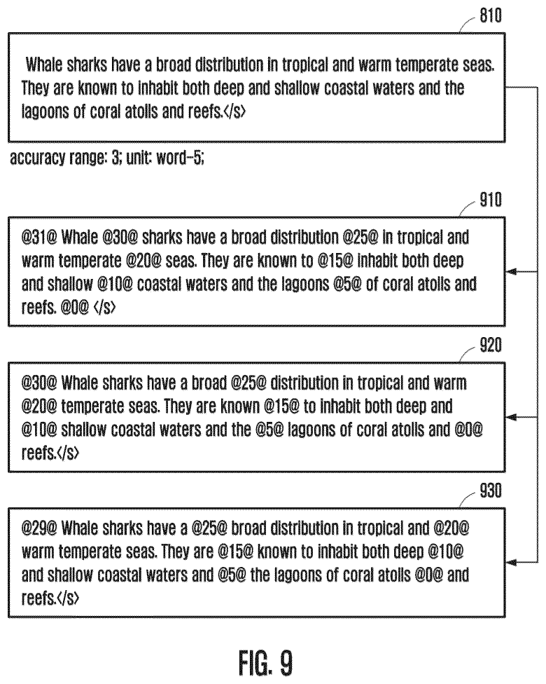

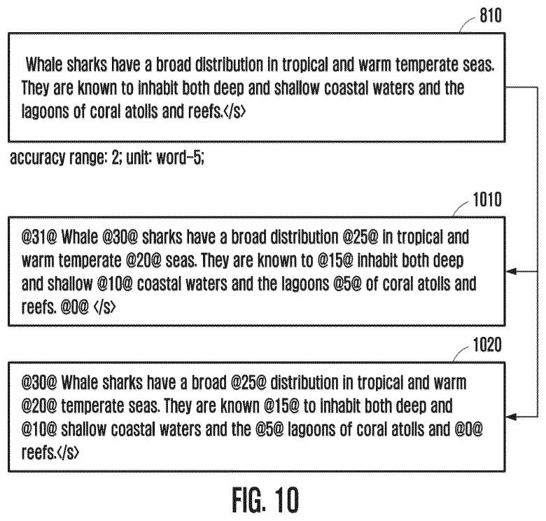

According to one or more embodiments, when the rule 603 related to the accuracy range is set to “3” (FIG. 9), “2” (FIG. 10), or “1” (FIG. 11), the data processing module 401 may generate second labels corresponding to the rule 603 based on the method described above. Redundant descriptions are omitted herein.

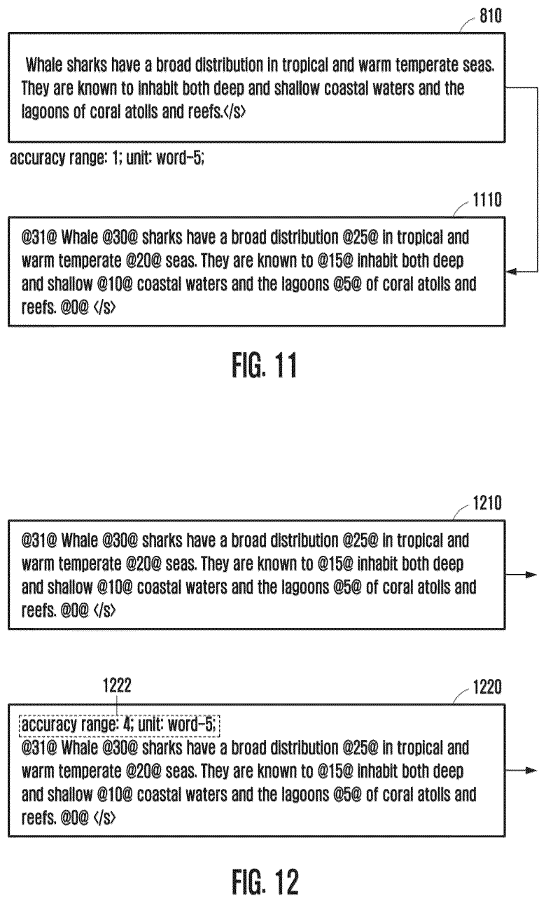

FIG. 12 is a diagram illustrating training data used to train a generative model according to one or more embodiments.

Referring to FIG. 12, according to one or more embodiments, a device (e.g., the server 121 of FIGS. 1 and 3) may train a generative model (e.g., the generative model 403 of FIG. 4) using a second label 1210 generated by the data processing module 401 and/or a rule (e.g., a rule 1222) used to generate the second label 1210. For example, the server 121 may use the second label 1210 as answer data. As another example, the server 121 may use the second label 1210 and a third label including the rule 1222 used to generate the second label 1210 as answer data.

FIG. 13 is a diagram illustrating a label according to one or more embodiments.

Referring to FIG. 13, according to one or more embodiments, a data processing module (e.g., the data processing module 401 of FIG. 4) may generate one or more second labels (e.g., a label 1310 and/or a label 1320) from the first label 810 for an input sequence (e.g., the full-length text sequence 710 of FIG. 7), based on a rule (e.g., the rule 605 of FIG. 6) related to a type of a token. For example, when the rule 605 related to the type of token is set to “word”, the data processing module 401 may generate the second label 1310. For example, when the rule 605 related to the type of token is set to “sentence”, the data processing module 401 may generate the second label 1320. As illustrated in label 1320, the first marker @2@ indicates that there are two sentences in the label 1320 between marker @2@ and the last marker @0 @. The second marker @1@ indicates that there is one sentence between the marker @1@ and the last marker @0@. When the rule 605 related to the type of token is set to “word and sentence”, the data processing module 401 may generate the second label 1310 and the second label 1320.

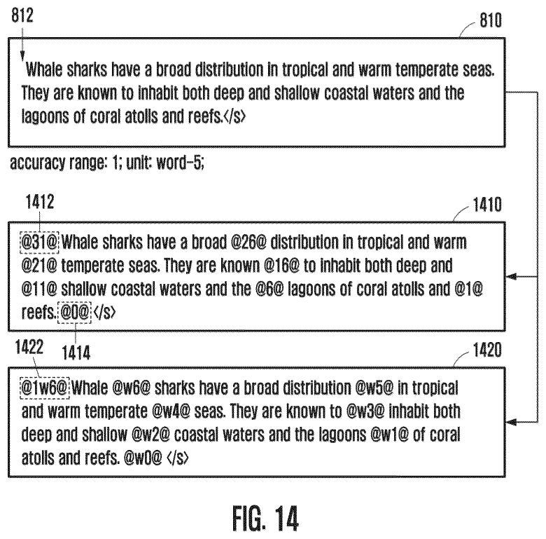

FIG. 14 is a diagram illustrating a label according to one or more embodiments.

Referring to FIG. 14, according to one or more embodiments, a rule (e.g., the rule 601 of FIG. 6) related to a format of a marker may include a rule with respect to a format of a marker (e.g., a marker 1412 or a marker 1422) to be inserted into the starting point 812 of the first label 810.

For example, the rule 601 may determine the format of the marker 1412 so that a character (e.g., “31”) included in the marker 1412 intuitively shows information on the number of tokens (e.g., words) included in the first label 810.

For example, the rule 601 may determine the format of the marker 1422 to minimize a token pattern to be learned by a generative model (e.g., the generative model 403 of FIG. 4). For example, the marker 1422 may express information on the number (e.g., 31) of tokens (e.g., words) included in the first label 810 by using a plurality of characters related to digits in each. For example, a first character (e.g., “1”) of the marker 1422 may provide information on the ones place (e.g., “1”) of the number (e.g., 31) of tokens included in the first label 810, and a second character (e.g., “6”) of the marker 1422 may provide information on the tens place of the number of tokens included in the first label 810.

FIG. 15 is a diagram illustrating a label according to one or more embodiments.

Referring to FIG. 15, according to one or more embodiments, a data processing module (e.g., the data processing module 401 of FIG. 4) may periodically, semi-periodically, and/or non-periodically insert markers into the first label 810, based on a rule (e.g., the rule 607 of FIG. 6) related to the number of tokens.

For example, the data processing module 401 may periodically (e.g., every 5 tokens) insert a plurality of markers (e.g., markers 1514-1 to 1514-7) after a marker 1512 that is inserted into the starting point 812 of the first label 810.

For example, the data processing module 401 may insert some markers based on a first token interval (e.g., 5 tokens) after the marker 1522 that is inserted into the starting point 812 of the first label 810, and may insert the remaining markers based on a second token interval (e.g., 1 token) that is different from the first token interval. As illustrated in FIG. 15, marker 1514-1 is inserted one word after marker 1512. Markers 1514-2 to 1514-7 are inserted periodically every 5 tokens after maker 1514-1.

In one or more examples, the data processing module 401 may also insert markers by sequentially reducing a token interval at which the markers are inserted. For example, the number of tokens included between two neighboring tokens may be sequentially reduced, such as five tokens, four tokens, three tokens, two tokens, and one token.

FIG. 16 is a diagram illustrating an inference process according to one or more embodiments.

Referring to FIG. 16, according to one or more embodiments, a data processing module 1601 and/or a generative model 1603 (e.g., the generative model 104 of FIG. 1) may be functions implemented by software (e.g., an instruction and/or a program) stored in a memory (e.g., the memory 203 of FIG. 2 and/or the memory 403 of FIG. 3) of a device (e.g., the electronic device 101 of FIGS. 1 and 2 and/or the server 121 of FIGS. 1 and 3) for inference. FIG. 16 is schematically illustrated to describe an inference process, and it is obvious to one of ordinary skill in the art that various modifications are possible. For example, the data processing module 1601 may be implemented as a part of the generative model 1603 or may be implemented by being divided into a plurality of modules.

According to one or more embodiments, the data processing module 1601 may perform pre-processing on input data. For example, when the data processing module 1601 receives a user input (e.g., the user input 11 of FIG. 1) to request to provide information on a specific object (e.g., “Michael Jackson”) for a specific time duration (e.g., 10 seconds), the data processing module 1601 may generate a prompt based on user data and/or linguistic characteristics (e.g., a speech rate). For example, the data processing module 1601 may determine the number of tokens (e.g., words) corresponding to the specific time duration, based on user data related to playback speed (e.g., 1 time, 1.25 times, or 1.5 times) preferred by a user. The data processing module 1601 may generate a prompt based on the determined number of tokens. For example, when the user input is “Tell me about Michael Jackson for a time duration of 10 seconds”, the data processing module 1601 may generate a prompt “Describe Michael Jackson in 30 words”. The data processing module 1601 may obtain the user data in various manners. For example, the user data may be obtained from data stored in the memory (e.g., the memory 203 of FIG. 2) of the electronic device 101. As another example, the user data may be received from an external electronic device (e.g., a server that manages a streaming application executed by the electronic device 101) that communicates with the electronic device 101. In one or more examples, the data processing module 1601 may use an LLM to generate a prompt.

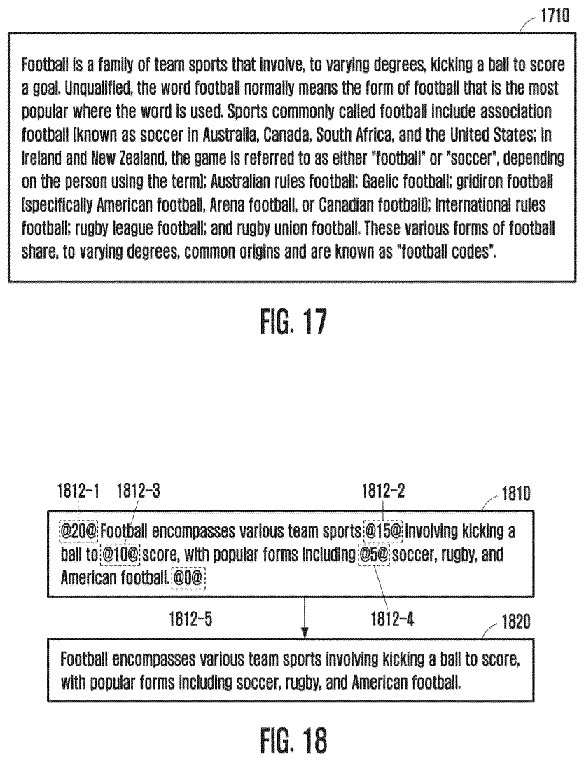

According to one or more embodiments, the data processing module 1601 may perform post-processing on an output of the generative model 1603. The post-processing performed by the data processing module 1601 is further described with reference to FIGS. 17 and 18.

According to one or more embodiments, the generative model 1603 may be a model trained based on the training algorithm described above. The generative model 1603 may generate and/or synthesize new data based on input data (e.g., a prompt). The generative model 1603 may control the length of an output (e.g., text) with high accuracy.

FIGS. 17 and 18 are diagrams illustrating outputs generated during an inference process according to one or more embodiments.

Referring to FIGS. 17 and 18, according to one or more embodiments, a generative model (e.g., the generative model 1603 of FIG. 16) may generate a summary (e.g., a summary 1810) of a full-length text sequence (e.g., a text sequence 1710). Since the generative model 1603 is trained based on a second label (e.g., the second label 820 of FIG. 2) including a plurality of markers (e.g., the markers 822, 824, 826-1 to 826-6 of FIG. 8) providing information on an end point (e.g., the end point 814 of FIG. 8) of a first label (e.g., the first label 810 of FIG. 8), the summary 1810 generated by the generative model 1603 may include one or more markers (e.g., markers 1812-1 to 1812-5).

According to one or more embodiments, a data processing module (e.g., the data processing module 1601 of FIG. 16) may generate a summary 1820 by removing a marker (e.g., the markers 1812-1 to 1812-5) from an output (e.g., the summary 1810) of the generative model 1603.

According to one or more embodiments, an electronic device (e.g., the electronic device 101 of FIGS. 1 and 2) may provide data (e.g., the summary 1820) post-processed by the data processing module 1601 to a user.

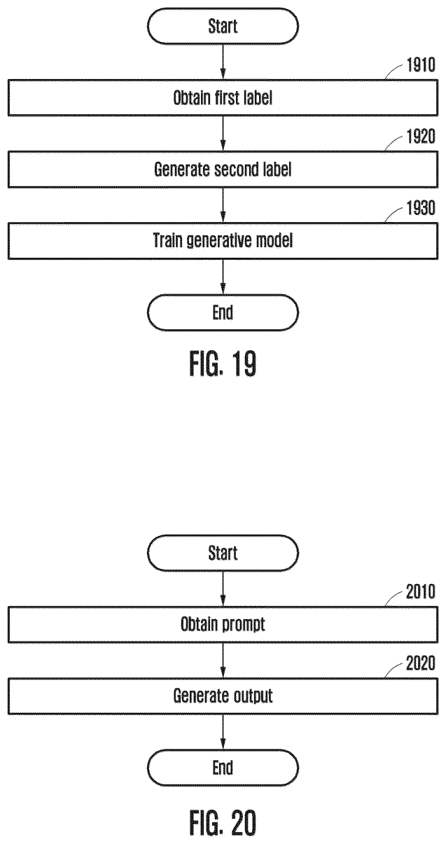

FIG. 19 is a flowchart illustrating operations performed by an electronic device to train a generative model according to one or more embodiments.

Referring to FIG. 19, according to one or more embodiments, operations 1910 to 1930 may be sequentially performed but are not limited thereto. For example, two or more operations may be performed in parallel or new operations may be added thereto. Operations 1910 to 1930 may be substantially the same as operations performed to train a generative model (e.g., the generative model 403 of FIG. 4) described with reference to FIGS. 4 to 15. Accordingly, a repeated description thereof is omitted.

In operation 1910, a device (e.g., the server 121 of FIGS. 1 and 3) may obtain a first label (e.g., the first label 810 of FIGS. 8 to 11 and FIGS. 13 to 15) for an input sequence (e.g., the full-length text sequence 710 of FIG. 7).

In operation 1920, the device 121 may generate a second label (e.g., the second labels 820 to 850 of FIG. 8, the second labels 910 to 930 of FIG. 9, the second labels 1010 and 1020 of FIG. 10, the second label 1110 of FIG. 11, the second label 1210 of FIG. 12, the second labels 1310 and 1320 of FIG. 13, the second labels 1410 and 1420 of FIG. 14, and/or the second labels 1510 and 1520 of FIG. 15) using a plurality of markers (e.g., the markers 822, 824, and 826-1 to 826-6 of FIG. 8) including information on an end point (e.g., the end point 814 of FIG. 8) of the first label 810.

In operation 1930, the device 121 may train the generative model 403 based on the input sequence 710 and the second labels 820 to 850, 910 to 930, 1010 and 1020, 1110, 1210, 1310 to 1320, 1410 and 1420, and 1510 and 1520.

FIG. 20 is a flowchart illustrating operations performed by an electronic device configured to perform inference using a trained generative model according to one or more embodiments.

Referring to FIG. 20, according to one embodiment, operations 2010 and 2020 may be sequentially performed but are not limited thereto. For example, new operations may be added thereto. Operations 2010 and 2020 may be substantially the same as the operations performed to generate an output using a trained generative model (e.g., the generative model 104 of FIG. 1 and/or the trained generative model 1603 of FIG. 16) described with reference to FIGS. 1 to 3 and 16 to 18. Accordingly, a repeated description thereof is omitted.

In operation 2010, a device (e.g., the electronic device 101 of FIGS. 1 and 2 or the server 121 of FIGS. 1 and 3) for inference may obtain a prompt. The prompt may include information on a length of an output of a generative model (e.g., the generative model 104 of FIG. 1 and/or the generative model 1603 of FIG. 16). For example, the device 101, 121 may obtain a prompt that requests to summarize a full-length text sequence (e.g., the full-length text sequence 1710 of FIG. 17) in a specific number of words (e.g., 20 words).

In operation 2020, the device 101, 121 may generate an output (e.g., the summary 1810 of FIG. 18) based on the prompt. The device 101, 121 may process the prompt using the trained generative model 104, 1603 to generate the output 1810.

A method performed by an electronic device to train a generative model according to one or more embodiments may include obtaining a first label for an input sequence.

The method may include generating a second label from the first label using a plurality of markers including information on an end point of the first label.

The method may include training the generative model based on the input sequence and the second label.

The generating of the second label may include generating, at each of a plurality of points of the first label, a marker related to a distance from each of the plurality of points to the end point of the first label.

The obtaining of the first label may include obtaining at least one summary of the input sequence.

The generating of the marker may include generating the marker at each of the plurality of points based on a preset rule.

The preset rule may include a rule with respect to at least one of a format of the marker, the number of tokens to be positioned after a last marker, a type of a token to be positioned between two neighboring markers, and the number of tokens to be positioned between the two neighboring markers.

Each of the plurality of markers may include at least one special token and a character that is able to express an order.

The generating of the marker may include inserting a first marker before a most preceding token of the first label.

The generating of the marker may include inserting one or more second markers into the first label based on the first marker.

A character included in the first marker may be determined based on the number of tokens to be positioned after the last marker among the second markers.

The inserting of the second markers may include periodically inserting the second markers into the first label based on the first marker.

Characters included in the second markers may be determined based on ascending order or descending order.

The training of the generative model may include training the generative model using the input sequence, the second label, and a rule used to generate the second label.

The generating of the second label may include the generating of a plurality of second labels from the first label.

The number of tokens positioned after a last marker of one of the plurality of second labels may be different from the number of tokens positioned after a last marker of another one of the plurality of second labels.

An electronic device according to one or more embodiments may generate data using a generative model trained by the method.

The electronic device according to one or more embodiments may include at least one processor.

The electronic device may include a memory storing instructions.

The instructions, when individually or collectively executed by the at least one processor, may cause the electronic device to obtain a prompt.

The instructions, when individually or collectively executed by the at least one processor, may cause the electronic device to process the prompt using an input sequence and a generative model trained based on a first label to generate an output.

The first label may be generated based on a plurality of markers including information on a second label for the input sequence and an end point of the second label.

The prompt may include information on a length of the output.

The instructions, when individually or collectively executed by the at least one processor, may cause the electronic device to generate the prompt based on user data on a preferred playback speed of the audio or video.

The second label may include one or more summaries of the input sequence.

The first label may include a marker inserted into each of a plurality of points of the second label.

The marker may be related to a distance from each of the plurality of points to an end point of the second label.

The instructions, when individually or collectively executed by the at least one processor, may cause the electronic device to generate a summary of target information (e.g., information on the full-length text sequence of FIG. 17 and/or information on an object included in a prompt) related to the prompt and a first output including a marker used to train the generative model.

The instructions, when individually or collectively executed by the at least one processor, may cause the electronic device to provide a user with a second output obtained by removing the marker from the first output.

According to one or more embodiments, a non-transitory computer-readable storage medium storing one or more computer programs may include instructions that cause a processor to perform the method.

An electronic device (e.g., the electronic device 101 of FIGS. 1 and 2) according to one or more embodiments provided herein may be various types of electronic devices. The electronic device 101 may include, for example, a portable communication device (e.g., a smartphone), a computer device, a portable multimedia device, a portable medical device, a camera, a wearable device, or a home appliance device. According to one embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Embodiment as set forth herein may be implemented as software (e.g., a program) including one or more instructions stored in a storage medium (e.g., a memory) that is readable by a machine (e.g., the electronic device 101 of FIGS. 1 and 2 and/or the server 121 of FIGS. 1 and 3). For example, a processor of the machine (e.g., the electronic device 101 and/or the server 121) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

The embodiments described above are examples to describe the technical idea of the present disclosure, and one of ordinary skill in the art may easily understand that the embodiments are easily modified in other detailed forms without modifying the technical idea or the essential feature of the present disclosure. Therefore, the embodiments described above shall be construed that the embodiments are examples in all aspects and are not limited. For example, one or a combination of two or more of the embodiments described above may also be included in the scope of the present disclosure.

According to one or more embodiments, a method according to one or more embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

The effects to be achieved are not limited to those described above, and other effects not mentioned above will be clearly understood by one of ordinary skill in the art from this document.

What is claimed is:

1. A method, performed by an electronic device, of training a generative model, the method comprising:
obtaining a first label for an input sequence;
generating a second label from the first label using a plurality of markers comprising information on a distance between a respective marker from the plurality of markers and an end point of the first label;
training the generative model based on the input sequence and the second label; and
modifying one or more parameters of the generative model based on the training of the generative model.

2. The method of claim 1, wherein the generating the second label comprises:
inserting, at each of a plurality of points of the first label, a marker from the plurality of markers at a position in the first label related to the distance from each of the plurality of points to the end point of the first label.

3. The method of claim 1, wherein the obtaining the first label comprises:
obtaining at least one summary of the input sequence.

4. The method of claim 2, wherein the inserting the marker comprises:
inserting the marker at each of the plurality of points based on a preset rule.

5. The method of claim 4, wherein the preset rule comprises a rule with respect to at least one of a format of the marker, a first number of tokens to be positioned after a last marker, a type of a token to be positioned between two neighboring markers, and a second number of tokens to be positioned between the two neighboring markers.

6. The method of claim 1, wherein each of the plurality of markers comprises at least one token and a character that indicates the distance from the respective marker to the endpoint of the first label.

7. The method of claim 2, wherein the inserting the marker comprises:
inserting a first marker before a most preceding token of the first label; and
inserting one or more second markers into the first label based on the first marker.

8. The method of claim 7, wherein a character comprised in the first marker is determined based on a number of tokens positioned after a last marker among the second markers.

9. The method of claim 7, wherein the inserting of the one or more second markers comprises:
inserting the second markers into the first label based on the first marker at one or more periodic intervals.

10. The method of claim 9, wherein a plurality of characters comprised in the second markers are determined based on an ascending order or a descending order of the plurality of characters.

11. The method of claim 1, wherein the training of the generative model further comprises:
training the generative model using the input sequence, the second label, and a rule used to generate the second label.

12. The method of claim 1, wherein the generating the second label comprises:
generating a plurality of second labels from the first label.

13. The method of claim 3, wherein a first number of tokens positioned after a last marker of one of the plurality of second labels is different from a second number of tokens positioned after a last marker of another one of the plurality of second labels.

14. An electronic device configured to generate data using a generative model trained by the method of claim 1.

15. An electronic device comprising:
at least one processor; and
a memory configured to store one or more instructions,
wherein the one or more instructions, when executed by the at least one processor, cause the electronic device to:
obtain a prompt, and
process the prompt, using an input sequence and a generative model trained based on a first label, to generate an output,
wherein the first label is generated based on a plurality of markers comprising information on a second label for the input sequence and an end point of the second label.

16. The electronic device of claim 15, wherein the prompt comprises information on a length of the output.

17. The electronic device of claim 15, wherein the one or more instructions, when executed by the at least one processor, to obtain the prompt, further cause the electronic device to:
generate the prompt based on user data on a playback speed of audio or a video.

18. The electronic device of claim 15, wherein the second label comprises one or more summaries of the input sequence.

19. The electronic device of claim 15, wherein the first label comprises a marker inserted into each of a plurality of points of the first label, and
the marker is related to a distance from each of the plurality of points to an end point of the second label.

20. The electronic device of claim 15, wherein the output comprises a summary of target information related to the prompt and a marker used to train the generative model.
